(19) United States
(12) Patent Application Publication
(10) Pub. No.: US 2015/0208004 A1
(43) Pub. Date: Jul. 23, 2015

(54) LOW LIGHT VISION ASSISTANCE

(71) Applicant: Matti Juhani Ruohonen, Turku (FI)

(72) Inventor: Matti Juhani Ruohonen, Turku (FI)

(73) Assignee: NOKIA CORPORATION, Espoo (FI)

(21) Appl. No.: 14/420,790

(22) PCT Filed: Aug. 14, 2012
(86) PCT No.: PCT/FI2012/050784

§ 371 Date: Feb. 10, 2015

(51) Int. Cl. H04N 5/33; B60R 1/00; H04N 5/74; H04N 5/232

(52) U.S. Cl. CPC H04N 5/33; H04N 5/23216; B60R 1/001; H04N 5/74; B60R 2300/205

(57) ABSTRACT

A portable unit for equipping vehicles for enhanced night vision system. The portable unit performs: presenting information to a user with a display of a portable unit; receiving by the portable unit an infrared image signal from an infrared camera; and presenting objects described by the infrared image signal to the user by the display of the portable unit. Corresponding method, apparatus, system and computer program are disclosed.

### TECHNICAL FIELD

The present application generally relates to low light vision assistance. The present application relates in particular, though not exclusively, to low light vision assistance of drivers of vehicles.

### BACKGROUND

Safety of vehicles has been improved in a number of ways including by reducing severity of consequences of collisions and by reducing likelihood of collisions by improving brake systems, designing stability improving systems and improving vision of the drivers with better headlamps.

However, there are limits for the improving of headlamps as too strong lights cause glaring of others drivers in traffic systems. For reducing these adverse effects, the strongest car lamps are automatically direction adjusted for keeping their beams aligned with the road. Such redirection systems are yet expensive and rather suited for installing on manufacture of cars. Infrared based night vision is another technique that has been used particularly in military applications. However, the infrared light is invisible to bare human eye and therefore the night vision has to be provided on a separate display. In result, the infrared night vision is still rather unusual in ordinary family cars.

### SUMMARY

Various aspects of examples of the invention are set out in the claims.

According to a first example aspect of the present invention there is provided an apparatus, comprising:
a portable unit;
in the portable unit, a display configured to present information to a user;
in the portable unit, a processor configured to receive an infrared image signal from an infrared camera and to cause presenting objects described by the infrared image signal to the user by the display.

According to a second example aspect of the present invention there is provided a method, comprising:
presenting information to a user with a display of a portable unit;
receiving by the portable unit an infrared image signal from an infrared camera; and
presenting objects described by the infrared image signal to the user by the display of the portable unit.

According to a third example aspect of the present invention there is provided an apparatus, comprising:
at least one processor; and
at least one memory including computer program code;
the at least one memory and the computer program code configured to, with the at least one processor, cause the apparatus to perform at least the following:
presenting information to a user with a display of a portable unit;
receiving by the portable unit an infrared image signal from an infrared camera; and
presenting objects described by the infrared image signal to the user by the display of the portable unit.

According to a fourth example aspect of the present invention there is provided a system, comprising:
the apparatus of the first or second example aspect; and
a vehicle comprising an auxiliary element configured to co-operate with the apparatus.

According to a fifth example aspect of the present invention there is provided a computer program, comprising:
code for presenting information to a user with a display of a portable unit;
code for receiving by the portable unit an infrared image signal from an infrared camera; and
code for presenting objects described by the infrared image signal to the user by the display of the portable unit;
when the computer program is run on a processor.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural overview of a system of an example embodiment of the invention;

FIG. 2 that shows a block diagram of a portable unit of another example embodiment in which the portable unit comprises the illumination unit, the visible light camera and the infrared camera;

FIG. 3 shows a flow chart that illustrates a process according to an example embodiment;

FIG. 4 shows a visible light camera image of a road in night time taken in low beam illumination of a car;

FIG. 5 shows an infrared camera image taken otherwise corresponding to FIG. 4; and

FIG. 6 shows a display image with warning indications provided according to an example embodiment.

### DETAILED DESCRIPTION OF THE DRAWINGS

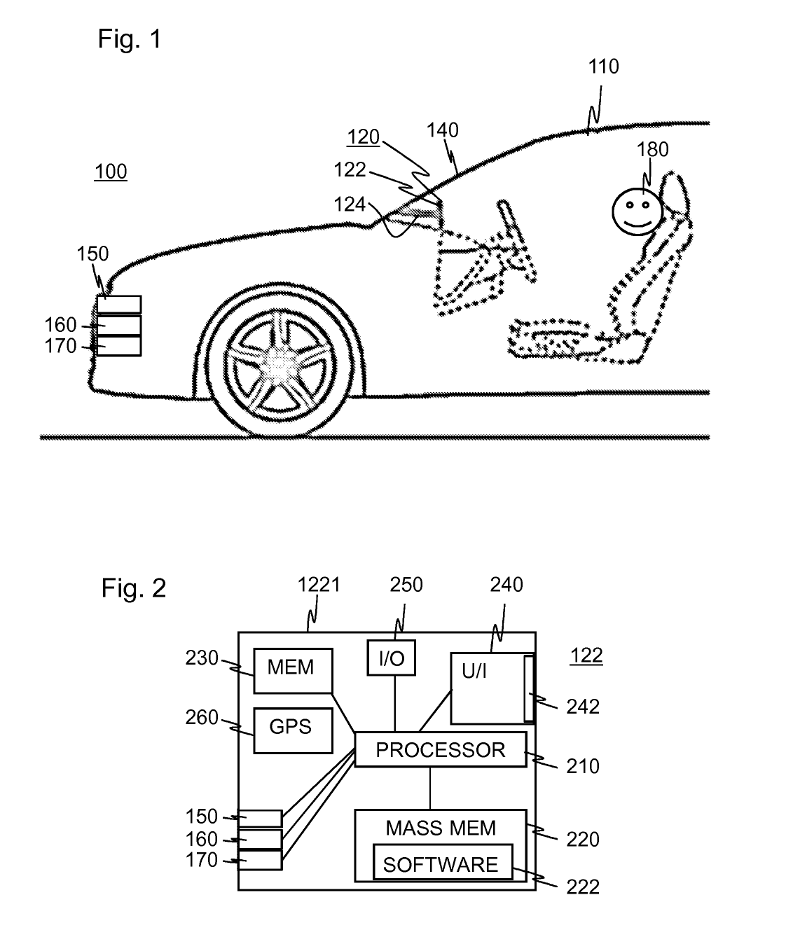

An example embodiment of the present invention and its potential advantages are understood by referring to FIGS. 1 through 6 of the drawings.

FIG. 1 shows an architectural overview of a system 100 of an example embodiment of the invention. The system 100 comprises a vehicle 110 such as a car, boat, or a lorry; an apparatus 120 that has a portable unit 122 and a holder 124 for supporting the portable 122 unit to some structure of the vehicle 110 or to a user 180, for example. The system further comprises a windshield 140, an infrared camera 150, a visible light camera 160 and an illumination unit 170 for facilitating the operation of the infrared camera 150 and/or of the visible light camera 160.

It should be understood that different example embodiments of the invention need not contain all of the elements shown in FIG. 1 or some of the shown elements can be located elsewhere. For instance, any one or more of the infrared camera 150, visible light camera 160 and illumination unit 170 can be located in the holder 124 or in the portable unit. While not drawn, the infrared camera 150 and the visible light camera 160 are communicatively connected to the portable unit 122 by wired connection such as a direct cable or car data bus such as CAN bus and/or by a wireless connection such as Bluetooth, wireless local area network (WLAN) or by an ultra-wide band (UWB) radio connection.

The portable unit 122 can be, for instance, a mobile phone, navigation device, music player, tablet computer, digital book, personal digital assistant or handheld game console.

The illumination unit 170 can be co-located with the headlamps of the vehicle 110. The illumination unit 170 can e.g. be configured to cast visible light as usual when in dark. In addition, the illumination unit can be configured to cast infrared light e.g. using a reflector of high beam headlamps. The illumination unit 170 can be located also elsewhere outside a cabin of the vehicle 110 e.g. in a front part of the vehicle 110.

In another example embodiment, in which the illumination unit 170 is located in the holder 124 and/or in the portable unit, the illumination unit can be configured to only cast infrared light so as to avoid causing stray light from reflecting to the eyes of the user 180.

The holder 124 is in one example embodiment a device without any other function than holding the portable unit 122 in place e.g. by using a suction cup or by using an adhesion plate that is fixed by glue or adhesive tape, for instance. The holder can also contain a light guide for guiding infrared light from the portable unit through the windshield 140 for illuminating objects outside the vehicle 110 by infrared light.

Let us next turn to FIG. 2 that shows a block diagram of a portable unit 122 of another example embodiment in which the portable unit 122 comprises the illumination unit 170, the visible light camera 160 and the infrared camera 150.

The portable unit 122 comprises a housing 1221; a processor 210; a mass memory 220 such as a flash ram, hard disk, solid state disk, optical memory; software 222 stored in the mass memory with e.g. an operating system, application programs and user and application data for long-term storage. Additionally, the portable unit 122 comprises a work memory 230 such as a random access memory running the software with the processor 210 if not executed in place in the mass memory. The portable unit 122 further comprises a user interface 240 that can have any user interface elements such as touch screen, keys, microphone, speaker and a display 242 for displaying information to the user 180. An input/output 250 can be provided for exchanging information with external devices. The input/output 250 can be, for example, a CAN bus interface, universal serial bus interface, Bluetooth interface, wireless local area network (WLAN) interface. Moreover, the portable unit 122 comprises a satellite navigation unit 260 such as a global positioning system (GPS) unit, a global navigation satellite system (GLONASS), or European Union's Galileo positioning system.

The processor 210 can be functionally connected to the illumination unit 170 as well as to the cameras so as to control their operation and receive the images taken by the cameras.

In another example embodiment with one or both cameras 150, 160 and/or with the illumination unit 170 located outside the portable unit 122, the corresponding communication is configured to flow through the input/output 250.

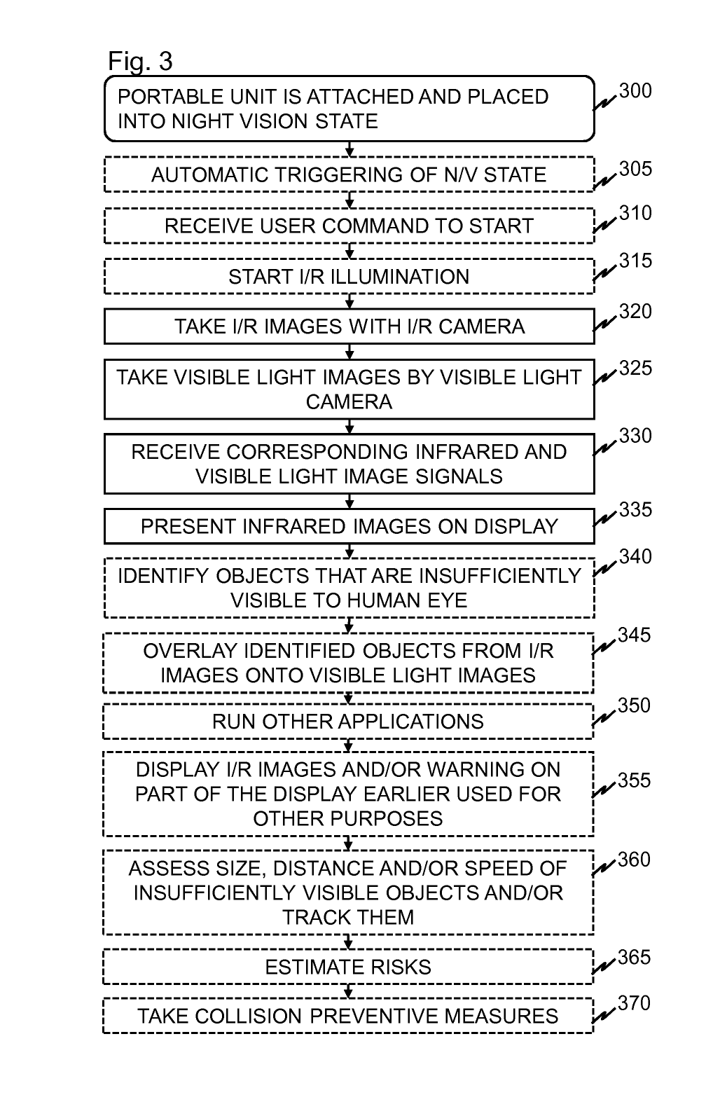

FIG. 3 shows a flow chart that illustrates a process according to an example embodiment.

In start 300, the portable unit 122 is attached using the holder 124 and placed into night vision state. In an example embodiment where the portable unit 122 comprises a satellite navigation module, the starting of the process can be automatically triggered by determining 305 that it is becoming dark and that the portable unit is in motion at a speed (e.g. 20 km/h to 150 or 200 km/h) that is indicative of moving with a vehicle that could be driven by the user 180. Alternatively, the process can be started by receiving 310 a command from the user 180 through the user interface 240.

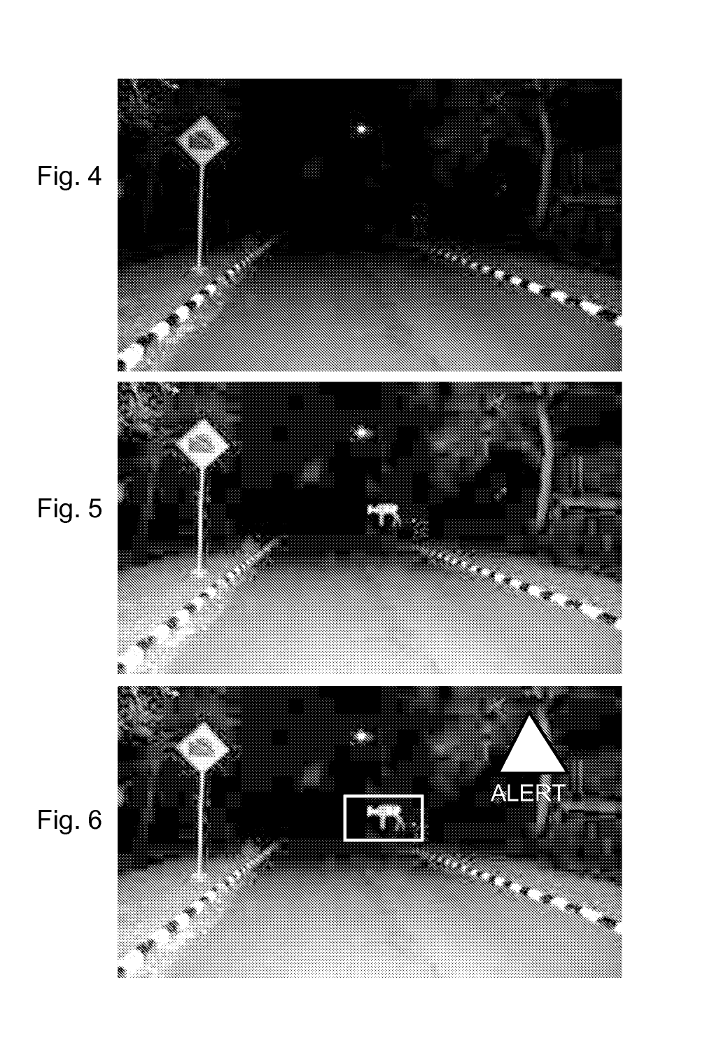

Infrared light illumination is started 315. Infrared images are taken 320 with the infrared camera 150 and visible light images are taken 325 by the visible light camera 160. FIG. 4 shows an example of such a visible light camera image taken of a road in night time in low beam illumination of a car and FIG. 5 shows an infrared camera image taken otherwise corresponding to FIG. 4.

The processor 210 receives corresponding infrared and visible light image signals, 330. The processor 210 presents infrared images 335 on the display 242 and thus shows any objects that were described by the infrared image signal. The processor 210 also identifies 340, in one example embodiment, objects that are insufficiently visible to human eye by comparing the visible light image signal with the infrared image signal. The objects that do not appear in the visible light camera signals but do appear in the infrared image signals can be defined as such insufficiently visible objects.

In one example embodiment, the processor identifies the insufficiently visible objects and overlays onto a visible light camera images instead of displaying the infrared images, 345.

The processor 210 can be configured to run applications such as music player or navigation applications, 350. While running such application or applications, the processor 210 can also perform the process illustrated by FIG. 3. If the processor 210 identifies an insufficiently visible object as described in the foregoing, the processor 210 can cause using some of the display 242 for displaying of infrared images and/or a warning on a part of the display 242 that earlier was used for other purposes, 355. The processor 210 can, for example, highlight such insufficiently visible objects on displaying.

In one example embodiment the processor 210 is also configured to assess the size, distance and/or speed of the insufficiently visible object and/or to track earlier insufficiently visible objects also after they become visible, 360. Based on the assessing, the processor 210 estimates 365 risks that these objects could cause. Depending on the estimated risk the processor 210 then either issues a warning or not. For example, the processor 210 can form visual highlighting around the identified (presently or earlier) insufficiently visible objects such as exemplified by FIG. 6 that shows a display image with warning indications provided according to an example embodiment. The warning indications can be displayed in bright colors and with blinking. Audible warning signals and/or messages can be issued additionally or alternatively. Moreover, in a further example embodiment, the processor 210 also takes collision preventive measures 370 if a collision appears to be imminent, e.g. starts instant braking or even adjusts the steering. For these example embodiments, the processor should have and use a secure access to a data bus of the vehicle 110 e.g. via the input/output 250 to relay commands to the vehicle's 110 relevant control systems such as brake control circuitry or steering control.

Without in any way limiting the scope, interpretation, or application of the claims appearing below, a technical effect of one or more of the example embodiments disclosed herein is existing vehicles can be relatively simply and inexpensively be equipped with enhanced night vision system. Another technical effect of one or more of the example embodiments disclosed herein is that by using a portable unit installation of otherwise unnecessary equipment can be avoided. In result, materials and energy may be saved both in terms of reduced need for additional equipment in comparison to installing equipment dedicated for night vision. Another technical effect of one or more of the example embodiments disclosed herein is that readily existing imaging equipment of the portable unit 122 can be employed for detecting normally invisible objects. Another technical effect of one or more of the example embodiments disclosed herein is that the holder 124 can be used to provide otherwise missing cameras or infrared illumination units.

Embodiments of the present invention may be implemented in software, hardware, application logic or a combination of software, hardware and application logic. The software, application logic and/or hardware may reside on the portable unit 122, in a circuitry comprised by the holder 124 or in circuitries built in the vehicle 110. If desired, part of the software, application logic and/or hardware may reside on the portable unit 122, part of the software, application logic and/or hardware may reside on in a circuitry comprised by the holder 124, and part of the software, application logic and/or hardware may reside or in circuitries built in the vehicle 110. In an example embodiment, the application logic, software or an instruction set is maintained on any one of various conventional computer-readable media.

In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 1 and 2 as the portable unit 122. A computer-readable medium may comprise a computer-readable storage medium that may be any media or means that can contain or store the instructions for use by or in connection with an instruction execution system, apparatus, or device, such as a computer. Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

If desired, the different functions discussed herein may be performed in a different order and/or concurrently with each other. Furthermore, if desired, one or more of the before-described functions may be optional or may be combined. For instance, infrared imaging can be performed without any separate infrared illumination, although often car lamps also produce some amount of infrared illumination as a by-product.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1. An apparatus, comprising:
a portable unit;
in the portable unit, a display configured to present information to a user;
in the portable unit, a processor configured to receive an infrared image signal from an infrared camera and to cause presenting objects described by the infrared image signal to the user by the display.

2. The apparatus of claim 1, further comprising the infrared camera.

3. The apparatus of claim 2, wherein the infrared camera is direction adjustable.

4. The apparatus of claim 2, wherein the portable unit comprises the infrared camera.

5. The apparatus of claim 1, wherein the display is a projector display configured to form images by projecting onto a windshield of a vehicle.

6. The apparatus of claim 1, further comprising a holder configured to hold the portable unit in place in a vehicle in a location visible to a driver of the vehicle.

7. The apparatus of claim 6, wherein the holder comprises the infrared camera.

8. The apparatus of claim 1, further comprising an infrared lamp configured to illuminate objects so as to facilitate the operation of the infrared camera.

9. (canceled)

10. (canceled)

11. The apparatus of claim 8, further comprising a holder configured to hold the portable unit in place in a vehicle in a location visible to a driver of the vehicle, wherein the holder comprises the infrared lamp.

12. The apparatus of claim 1, wherein the processor is further configured to receive a visible light image signal from a visible light camera that has an overlapping field of view with the infrared camera and to identify objects that are insufficiently visible to human eye by comparing the visible light image signal with the infrared image signal.

13. (canceled)

14. (canceled)

15. The apparatus of claim 12, wherein the visible light camera is in the portable unit.

16. The apparatus of claim 12,
further comprising the visible light camera in the a holder configured to hold the portable unit in place in a vehicle in a location visible to a driver of the vehicle.

17. (canceled)

18. The apparatus of claim 12, wherein the processor is further configured to:
run an application and cause displaying of information related to the application; and
terminate the causing of displaying of information related to the application on at least a portion of the display and instead form and cause displaying of an image comprising the identified objects that are insufficiently visible to human eye.

19. The apparatus of claim 18, wherein the application is a navigation application.

20. (canceled)

21. The apparatus of claim 12, wherein the processor is further configured to issue an alarm when identifying objects that are insufficiently visible to human eye.

22. (canceled)

23. The apparatus of claim 12, wherein the processor is further configured to estimate risks that the identified objects that are insufficiently visible to human eye could cause and to cause take collision preventive measures if necessary.

24. A method comprising:
presenting information to a user with a display of a portable unit;
receiving by the portable unit an infrared image signal from an infrared camera; and
presenting objects described by the infrared image signal to the user by the display of the portable unit.

25. The method of claim 24, further comprising forming the infrared image signal by an infrared camera.

26. The method of claim 24, wherein the presenting of the objects comprises projecting images onto a windshield of a vehicle.

27. (canceled)

28. (canceled)

29. (canceled)

30. (canceled)

31. (canceled)

32. The method of claim 24, further comprising issuing an alarm when identifying objects that are insufficiently visible to a human eye.

33. (canceled)

34. (canceled)

35. (canceled)

36. (canceled)

37. (canceled)

38. (canceled)

39. (canceled)

40. (canceled)

41. (canceled)

42. (canceled)
